(19) United States
(12) Patent Application Publication
(10) Pub. No.: US 2009/0142233 A1
(43) Pub. Date: Jun. 4, 2009

(54) Gas sensor system

(76) Inventors: Dennis M. Antieau, Coarsegold, CA (US); Lance Lowe, Cerritos, CA (US)

Correspondence Address: K&L GATES LLP, 535 SMITHFIELD STREET, PITTSBURGH, PA, 15222, US

(21) Appl. No.: 12/005,009

(22) Filed: Dec. 20, 2007

Related U.S. Application Data
(60) Provisional application No. 61/005,252, filed on Dec. 4, 2007.

(51) Int. Cl. B01J 19/00

(52) U.S. Cl. 422/83

(57) ABSTRACT

A system including a sensor and a sensor holder. The sensor includes an inlet port for receiving a gas sample and an outlet port for exhausting a portion of the gas sample. The sensor generates an output signal indicative of an oxygen concentration of the gas sample. The sensor holder removably receives and contains the sensor and includes an inlet port for communicating the gas sample to the sensor and an outlet port for receiving the exhausted portion of the gas sample from the sensor. The inlet port of the sensor holder is aligned and sealably interfaced with the inlet port of the sensor such that the inlet ports defining a common inlet bore. The outlet port of the sensor holder is aligned and sealably interfaced with the outlet port of the sensor such that the outlet ports defining a common outlet bore.

### CROSS-REFERENCE TO RELATED APPLICATION

This application claims priority from the U.S. Provisional Patent Application having Ser. No. 61/005,252 filed Dec. 4, 2007, the disclosure of which is incorporated herein by reference.

### TECHNICAL FIELD

The present disclosure relates generally and in various embodiments to a gas sensor system including a sensor and a sensor holder.

### BACKGROUND

FIG. 1 illustrates a cross-sectional view of a fast oxygen sensor 5, such as, for example, a UFO-130 fast oxygen sensor available from Teledyne Analytical Instruments, City of Industry, Calif., suitable for use in fast oxygen sensing applications. A “fast oxygen sensing application” generally refers to an application it which the oxygen content of a gas sample must be determined within a relatively short time span, typically on the order of 100 milliseconds or less. Fast oxygen sensing applications may include, for example, respiratory monitoring applications in which it is necessary to measure the oxygen content of exhaled gases on a breath-by-breath basis.

As shown in FIG. 1, the sensor 5 includes a cathode 10 and an anode 15 sealed in a housing 20 filled with an appropriate liquid electrolyte solution 25. The sensor 5 further includes a cap 30 formed on the bottom of the housing 20 and enclosing an opening 35 defined by the housing 20. A gas sample is introduced into the opening 35 and exhausted therefrom via an inlet port 40 and an outlet port 45, respectively, formed on an exterior of the cap 30 and defining corresponding openings therein. The inlet port 40 may include a barbed nipple for removably coupling a flexible gas supply line 50, and the outlet port 45 may include a luer-type connector for removably coupling an oppositely gendered gas exhaust line 55. Integrating the inlet and outlet ports 40, 45 directly onto the sensor 5 minimizes the amount of “dead space” in which residual amounts of previous gas samples may remain. In this way, the degree by which a current gas sample is diluted by previous gas samples is reduced significantly, improving the integrity of the current gas sample and, correspondingly, the accuracy of the oxygen concentration indicated by the sensor 5.

During operation of the sensor 5, a gas sample received through the opening 35 is passed into the interior of the housing 20 through a thin sensing membrane 60. A flexible expansion membrane 65 at the opposite end of the sensor 5 permits expansion and contraction of the electrolyte volume. A printed circuit board (PCB) 70 mounted above the expansion membrane 65 may include an electrical output connector 75 having contacts electrically connected to the cathode 10 and the anode 15. The output connector 75 is configured to removably engage a sensor output cable 80 to establish an electrical connection between the cathode 10 and anode 15 through an externally located sensing circuit (not shown). At the cathode 10, reduction of oxygen contained in the gas sample causes ionic current to flow from the cathode 10 to the anode 15 via the sensing circuit. Based on the magnitude of the ionic current, the oxygen content of the sampled gas may be determined by the sensing circuit.

Although sensor holders for removably housing an oxygen sensor so that gas samples may be circulated about the sensor within a sealed volume are known, such holder/sensor combinations typically introduce significant amounts of dead space and may thus be unsuitable for use in fast oxygen sensing applications. Incorporation of the inlet and outlet ports directly onto a sensor used in a fast oxygen sensing application, as described above, has therefore been viewed as largely necessary in order to acceptably reduce the amount of dead space.

In view of the need to physically connect to connections on the sensor 5 using gas supply and exhaust lines, equipment hosting the sensor 5 is typically designed such that the sensor 5 is internally contained. Disadvantages of this arrangement include the need for specialized tools and/or technically trained personnel familiar with the equipment to replace the sensor, the risk of damage to neighboring electrical devices during a replacement procedure, and generally, the increased operating expenses. Additionally, replacement procedures using such arrangements are often time consuming, requiring up to twenty minutes in some cases. The resultant delay in equipment operation is generally undesirable and may in fact be unacceptable in certain oxygen sensing applications (e.g., monitoring respiratory functions of a patient) in which substantially uninterrupted gas sampling may be critical.

What is needed, therefore, is a gas sensing system suitable for use in fast oxygen sensing applications that permits a sensor to be quickly and efficiently deployed into operation and replaced with a minimum of time delay and without the use of specialized tools or technically trained personnel, while at the same time minimizing dead space in order to ensure an accurate determination of oxygen content.

### SUMMARY

In one general respect, the present application is directed to a system including a sensor and a sensor holder. The sensor includes an inlet port for receiving a gas sample and an outlet port for exhausting a portion of the gas sample. The sensor generates an output signal indicative of an oxygen concentration of the gas sample. The sensor holder removably contains the sensor and includes an inlet port for communicating the gas sample to the sensor and an outlet port for receiving the exhausted portion of the gas sample from the sensor. The inlet port of the sensor holder is aligned and sealably interfaced with the inlet port of the sensor such that the inlet ports define a common inlet bore. The outlet port of the sensor holder is aligned and sealably interfaced with the outlet port of the sensor such that the outlet ports define a common outlet bore.

In another general respect, the present application is directed to an apparatus including a sensor cell and a gas sensor cap. The sensor cell includes a surface forming an opening to receive a gas sample and generates an output signal indicative of an oxygen concentration of the gas sample. The gas sensor cap includes an inlet port and outlet port and engages the surface of the sensor cell to define a first volume and a second volume. The first volume receives the gas sample from the inlet port and communicates the gas sample to the opening of the sensor cell. The second volume receives an exhausted portion of the gas sample from the first volume and communicates the exhausted portion of the gas sample to the outlet port. The apparatus further includes a sleeve to contain the sensor cell and the gas sensor cap. The apparatus is configured to be removably received and contained in a sensor holder such that the inlet and outlet ports of the gas sensor cap are respectively aligned and sealably interfaced with inlet and outlet ports of the sensor holder to define a common inlet bore and a common outlet bore.

### DESCRIPTION OF THE FIGURES

FIG. 1 illustrates a cross-sectional view of a fast oxygen sensor;

FIG. 2 illustrates a perspective view of one embodiment of a gas sensing system;

FIGS. 3A and 3B illustrate perspective views of the embodiment of the sensor holder body shown in FIG. 2;

FIG. 3C is a cross-sectional view of the embodiment of the sensor holder body shown in FIG. 3A taken along line 3C-3C;

FIG. 3D is a cross-sectional view of the embodiment of the sensor holder body shown in FIG. 3B taken along line 3D-3D;

FIG. 3E is a side view of an embodiment of the sensor holder body;

FIG. 4 illustrates an exploded view of the embodiment of the sensor holder door shown in FIG. 2;

FIGS. 5A and 5B illustrate perspective views of the embodiment of the door member shown in FIG. 4;

FIGS. 6A and 6B illustrate perspective views of the embodiment of the distal door cap shown in FIG. 4;

FIG. 7A illustrates a perspective view of the embodiment of the proximal door cap shown in FIG. 4;

FIG. 7B is a cross-sectional view of the embodiment of the proximal door cap shown in FIG. 7A taken along line 7B-7B;

FIG. 8 illustrates an exploded view of the embodiment of the sensor shown in FIG. 2;

FIGS. 9A and 9B illustrate perspective views of the embodiment of the sensor cell shown in FIG. 8;

FIG. 10A illustrates a perspective view of the embodiment of the sensor sleeve shown in FIG. 8;

FIG. 10B is a cross-sectional view of the embodiment of the sensor sleeve shown in FIG. 10A taken along line 10B-10B;

FIGS. 11A and 11B illustrate perspective views of the embodiment of the proximal sensor cap shown in FIG. 8;

FIGS. 12A and 12B illustrate perspective views of the embodiment of the distal sensor cap shown in FIG. 8;

FIG. 12C is a cross-sectional view of the embodiment of the distal sensor cap shown in FIG. 12A taken along line 12C-12C;

FIG. 12D illustrates a perspective view of the gas distribution nozzle of the embodiment of the distal sensor cap shown in FIGS. 12A and 12B;

FIG. 13 illustrates a perspective view of an embodiment of the distal sensor cap retainer shown in FIG. 8;

FIGS. 14A and 14B are cross-sectional views of the embodiment of the sensor shown in FIG. 2;

FIGS. 15A and 15B are cross-sectional views of the embodiment of the system shown in FIG. 2 with the sensor contained within the sensor holder;

FIG. 16 is a schematic diagram of the PCB signal conditioning circuit according to one embodiment; and

FIG. 17 is a schematic diagram of a host containing the system of FIG. 2.

### DESCRIPTION

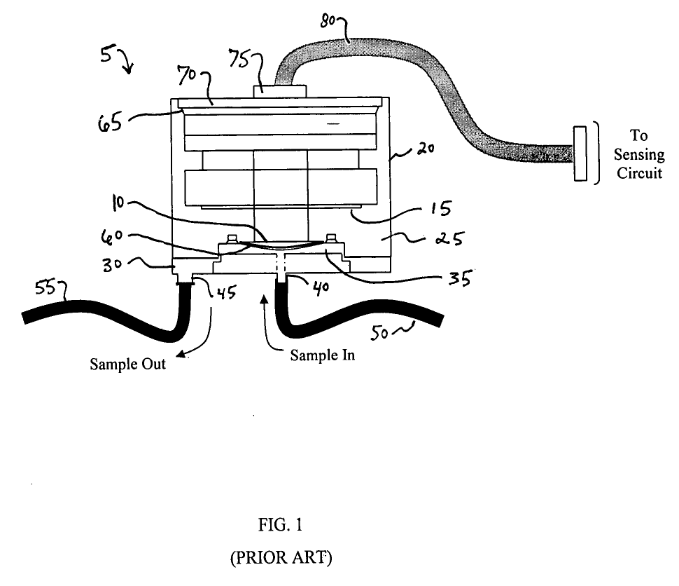

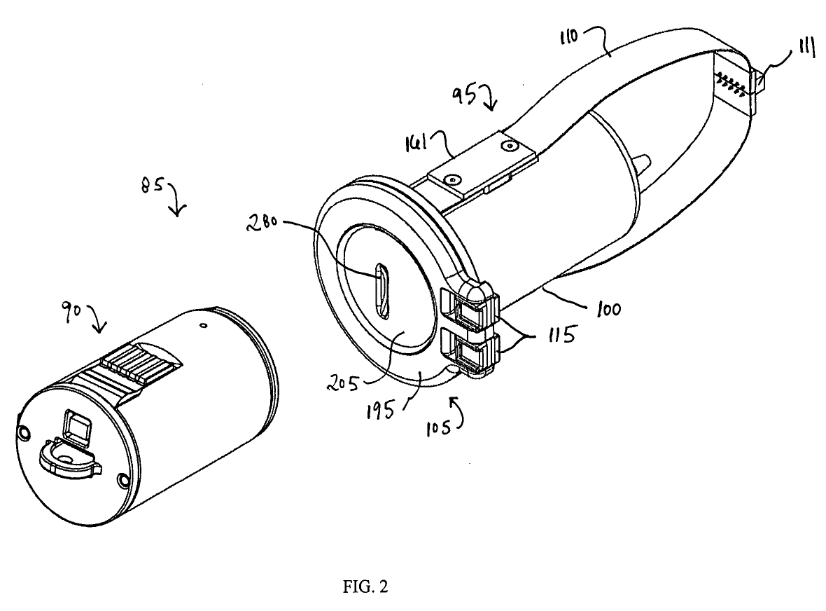

FIG. 2 illustrates one embodiment of a gas sensing system 85. The system 85 may include one embodiment of an oxygen sensor 90 and one embodiment of a sensor holder 95 to removably receive and contain the sensor 90 during operation of the system 85. For the sake of clarity, the sensor 90 is depicted in FIG. 2 in an uninstalled state with respect to the sensor holder 95. As described in further detail below, the sensor 90 may include components similar to those described above in connection with FIG. 1 and which function to generate ionic current when exposed to a gas sample containing oxygen. The system 85 is thus generally suitable for integration with any type of new or existing host equipment that requires or may otherwise benefit from the use of a galvanic-type oxygen sensor to determine the oxygen content of gas samples. As will be appreciated from the exemplary embodiments described herein, the system 85 affords rapid and efficient access to the sensor 90 via the sensor holder 95 from the exterior of the host equipment without any need for specialized equipment or technical expertise. Additionally, features of the sensor 90 and the sensor holder 95 are such that the deadspace characteristic of conventional sensor holder designs is greatly diminished. These and other advantages of the system 85 make it particularly well suited for integration with equipment used in fast oxygen sensing applications such as, for example, respiratory equipment used for medical treatment or cardiovascular assessment.

Still with reference to FIG. 2, the sensor holder 95 may include a sensor holder body 100, a sensor holder door 105 pivotally attached to a proximal end of the sensor holder body 100, and a multi-conductor sensor holder cable 110 attached to a sidewall 115 of the sensor holder body 100. It will be appreciated that the terms “proximal” and “distal” are used herein with reference to a user viewing the sensor holder door 105 with the door 105 in a closed position relative to the sensor holder body 100 (as shown in FIG. 2) and with the sensor 90 installed into the sensor holder 95. Thus, for example, the sensor holder body 100 is distal with respect to the more proximal sensor holder door 105.

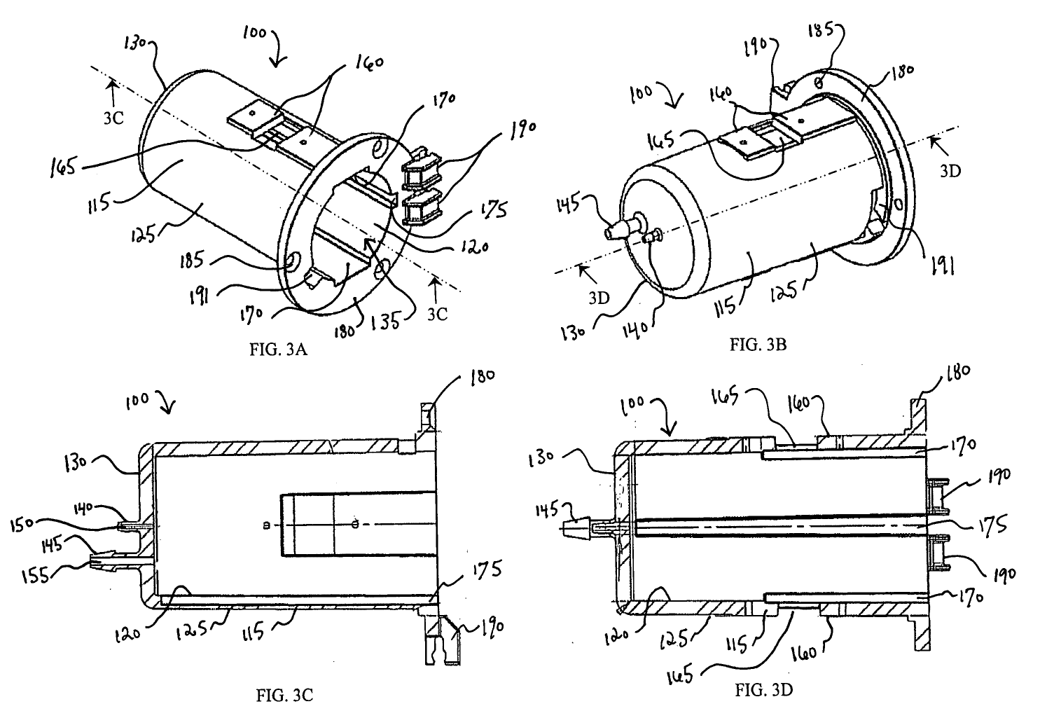

FIGS. 3A and 3B are proximal and distal perspective views, respectively, of the sensor holder body 100 of FIG. 2, and FIGS. 3C and 3D are cross-sectional side views of the sensor holder body 100 of FIGS. 3A and 3B taken along lines 3C-3C and 3D-3D, respectively. As shown in FIGS. 3A and 3B, the sensor holder body 100 may include a generally cylindrical sidewall 115 having an interior surface 120 and an exterior surface 125. The sensor holder body 100 may further include a generally flat base 130, best seen in FIG. 3B, attached to the distal end of the sidewall 115. The interior sidewall surface 120 and the base 130 together define a generally cylindrical receptacle 135 in which the sensor 90 is removably contained during operation of the system 85. In certain embodiments, the sensor holder body 100 may be fabricated as an integral component from a suitable thermoplastic material (e.g., ABS plastic) using, for example, injection molding.

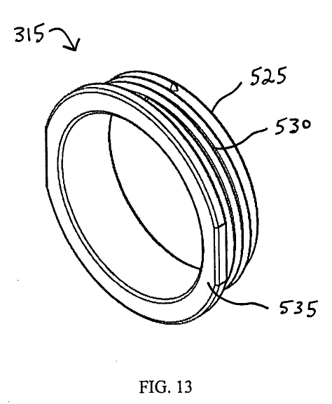

The base 130 includes an inlet port 140 and an outlet port 145. As shown in FIG. 3B, the inlet port 140 may be centrally located on a distal surface of the base 130 and may include a first barbed nozzle extending in a direction normal to the base 130. The inlet port 140 may define an open-ended coaxial bore 150 (FIG. 3C) having a first end that opens from a distal end of the inlet port 140 and a second end that opens into the receptacle 135 from a proximal surface of the base 130. As further shown in FIG. 3B, the outlet port 145 may be located on the distal surface of the base 130 between the inlet port 140 and the sidewall 115 and include a second barbed nozzle extending in a direction normal to the base 130. The outlet port 145 may define an open-ended coaxial bore 155 (FIG. 3C) having a first end that opens from a distal end of the outlet port 145 and a second end that opens into the receptacle 135 from the proximal surface of the base 130. When the sensor 90 is contained within the receptacle 135, the inlet and outlet ports 140, 145 of the sensor holder body 100 may be aligned and sealably interfaced with corresponding inlet and outlet ports 455, 460 (FIGS. 12B and 12C) of the sensor 90. In this way, during operation of the system 85, gas samples may be introduced to and exhausted from the sensor 90 via corresponding gas supply lines (not shown) connected to the inlet and outlet ports 140, 145, respectively. As shown in FIG. 3C, the bore diameter of the outlet port 145 may be larger than that of the inlet port 140 in order to reduce flow resistance encountered by exhausted gas samples.

The sidewall 115 of the sensor holder body 100 may include planar contact mounting surfaces 160 formed on opposing sides of the exterior sidewall surface 125. Each contact mounting surface 160 may accommodate a corresponding modular contact 161 (FIG. 2) of the sensor holder cable 110 and define a contact aperture 165 through which electrical wipes of the modular contact 161 may inwardly extend. The electrical wipes of each modular contact 161 may extend beyond the interior sidewall surface 120 such that each wipe removably engages a corresponding electrical wipe of the sensor 90 when the sensor 90 is contained within the receptacle 135.

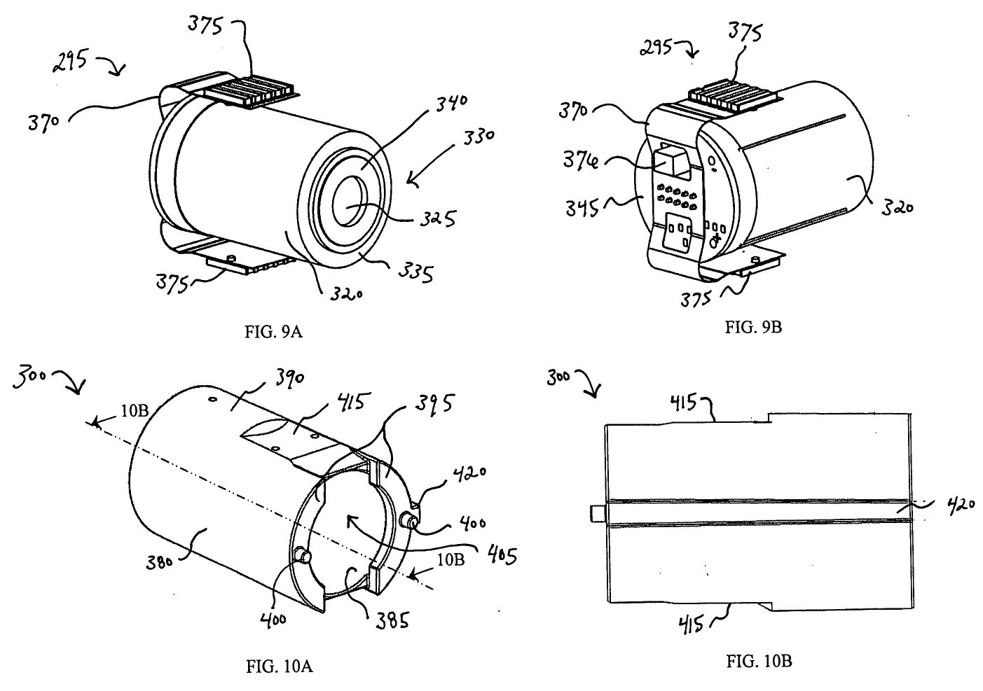

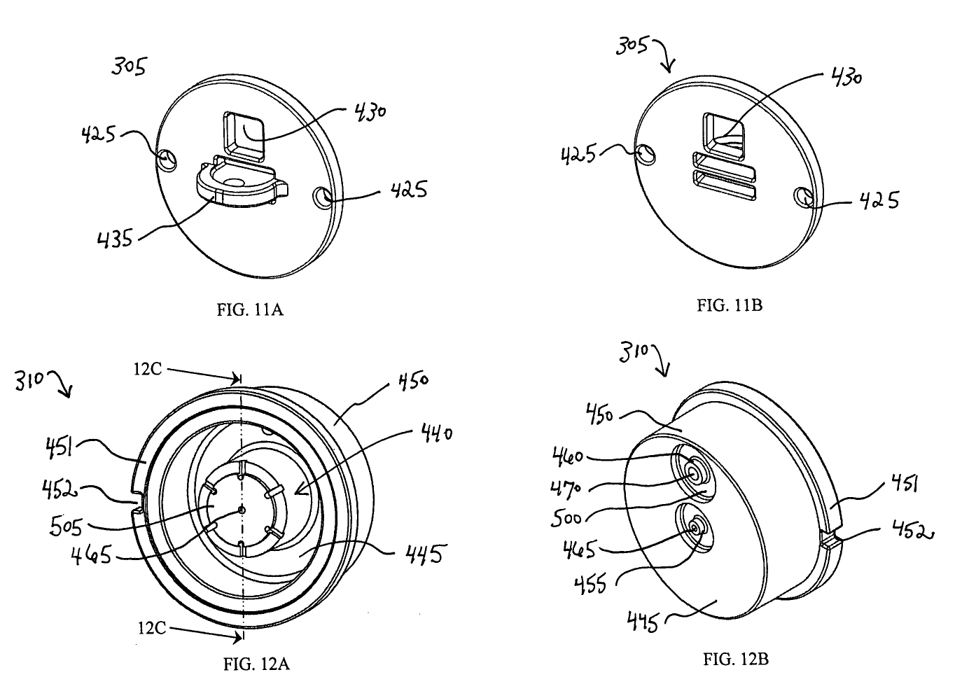

As best seen in FIGS. 3A and 3D, contact guide slots 170 may be formed in the interior sidewall surface 120 to ensure that modular contacts 375 of the sensor 90 (FIGS. 9A and 9B) are properly aligned with corresponding modular contacts 161 of the sensor holder cable 110 when the sensor 90 is contained within the receptacle 135. As shown in FIGS. 3A, 3C and 3D, the interior sidewall surface 120 may additionally include a key slot 175 formed therein and extending from the mouth of the receptacle 135 to the proximal surface of the base 130. Insertion of the sensor 90 into the receptacle 135 is permitted only when the key slot 175 is aligned with an alignment key 420 (FIG. 10B) extending over the length of the sensor 90. The sensor 90 is thus mechanically polarized with respect to the sensor holder 95 and may be received into the receptacle 135 only when the sensor 90 is in the correct rotational orientation.

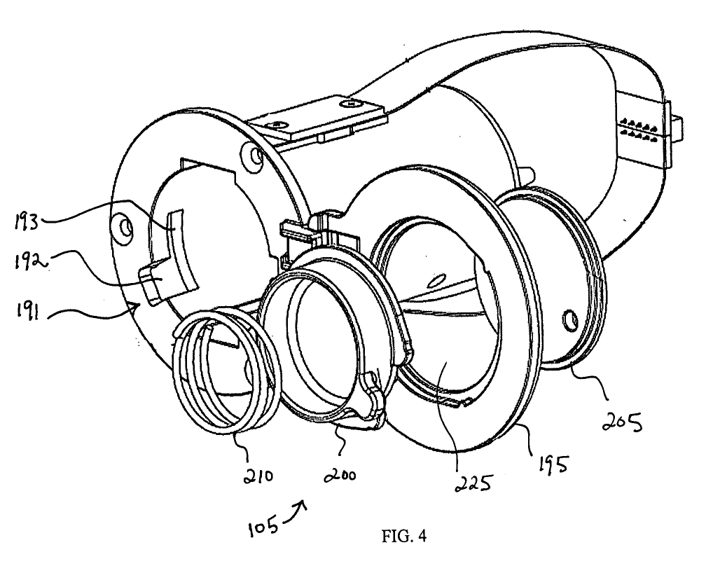

The sensor holder body 100 may further include a mounting flange 180 formed on the periphery of the sidewall 115 at its proximal end for mechanically attaching the sensor holder 95 to an item of host equipment (not shown). The exterior of the host equipment may include, for example, a flat surface defining a suitable opening through which the distal end of the sensor holder body 100 may be received. The sensor holder body 100 may be inserted through the opening until a distal surface of the flange 180 is flush with the equipment surface. As shown, the flange 180 may include a plurality of mounting holes 185 for receiving therethrough suitable attachment devices (e.g., screws, bolts, rivets, etc.) to anchor the flange 180 to the equipment surface. Alternatively, attachment structures (e.g., distally extending threaded posts) may be integrally formed on the flange 180 for enabling flange 180 attachment. As best shown in FIG. 3A, the flange 180 may further include hinge barrels 190 integrally formed on a rim of the flange 180 for engagably retaining corresponding hinge pins 220 (FIGS. 5A and 5B) of the sensor holder door 105. As shown in FIG. 3C, the hinge barrels 190 may be open-ended such that the sensor holder door 105 may be attached or removed from the sensor holder body 100 as needed.

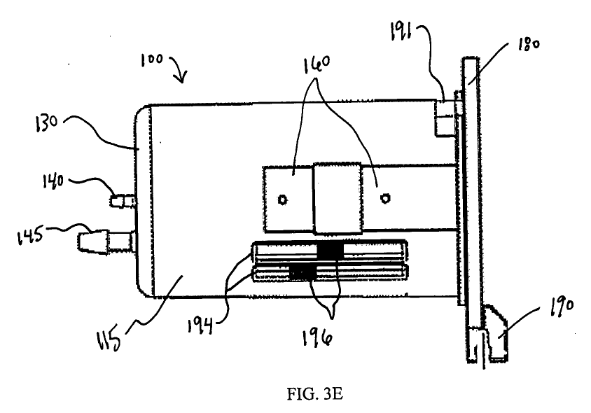

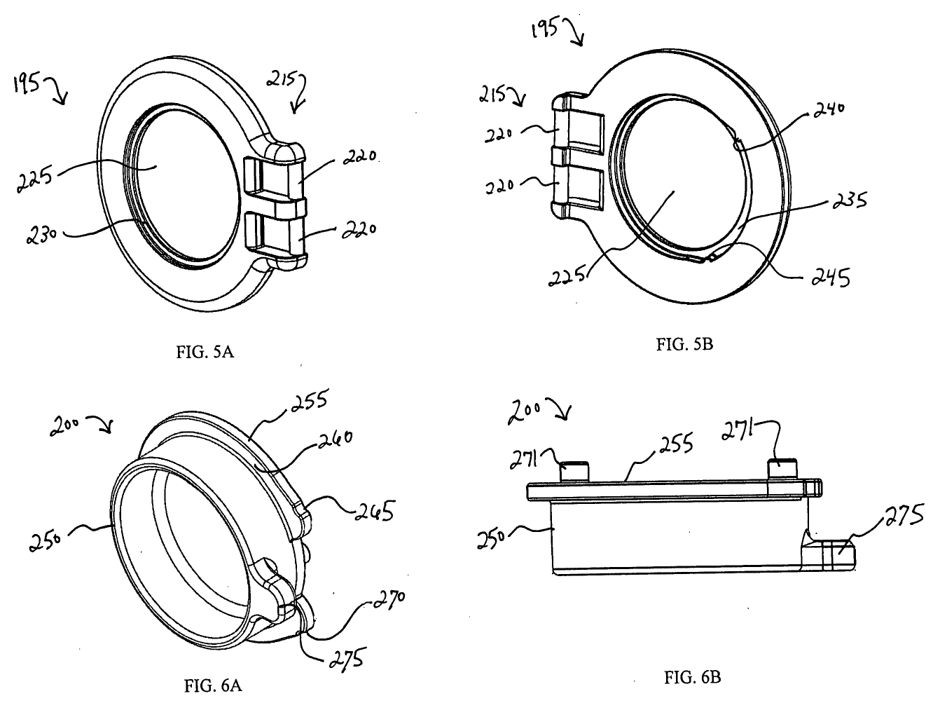

The sensor holder body 100 may further include a lock slot 191 for receiving a corresponding lock tab 275 (FIGS. 6A and 6B) of the sensor holder door 105 to enable closure and locking/unlocking of the sensor holder door 105. As best shown in FIG. 4, the lock slot 191 may be generally L-shaped and include a first slot portion 192 extending distally from the mouth of the receptacle 135 through an inner rim of the flange 180 and through a portion of the sidewall 115. The lock slot 191 may further include a second slot portion 193 formed through the sidewall 115 and extending perpendicularly relative to the first slot portion 192. Alignment of the lock tab 275 with the first slot portion 191 permits the door to be closed and opened, and movement of the lock tab 275 to and from the second slot portion 193 effects the locking and unlocking, respectively, of the sensor holder door 105.

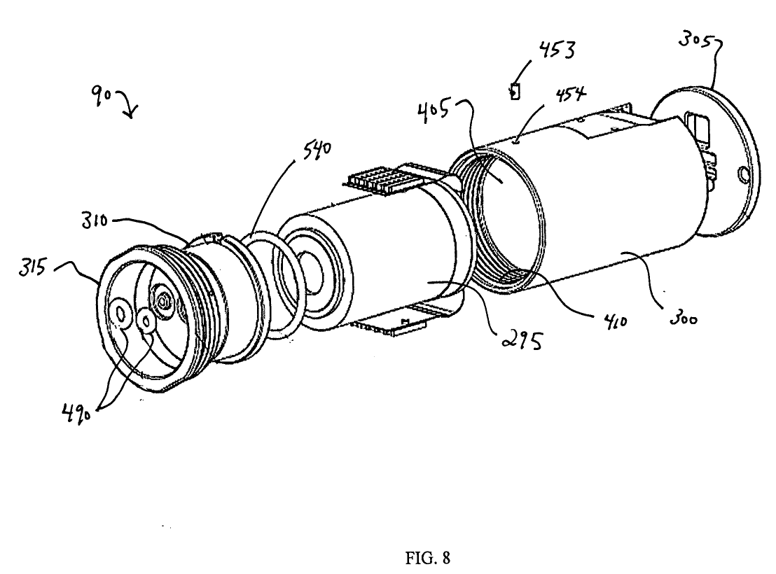

In certain embodiments and as shown in FIG. 3E, the sensor holder body 100 may also include one or more sensor apertures 194 formed through the sidewall 115 for containing one or more temperature sensors 196. Each temperature sensor 196 may generally be any type of suitable temperature-sensing device such as, for example, a thermocouple, thermistor, or RTD, for indicating a temperature within the system 85. In FIG. 3E, the sensor apertures 194 are depicted in the form of adjacent slots of generally equal length which extend longitudinally over a portion of the sensor holder body 100. The temperature sensors 196 may be mounted within the slots using, for example, a suitable epoxy material. The outputs of the temperature sensors 196 may be used to compensate temperature-dependent output error of the sensor cell 295 (FIG. 8). Output leads (not shown) from each sensor 196 may connect to the sensor cell 295 such that the temperature sensor outputs may be communicated to the host system for processing therein via the sensor cable 370 (FIG. 9A) and the sensor holder cable 110. In other embodiments, the sensor cell 295 may process the temperature sensor outputs and perform temperature compensation locally, and in yet other embodiments, the sensor leads may bypass the sensor cell 295 altogether and connect directly with the host equipment via the sensor holder cable 110.

FIG. 4 is an exploded view of the sensor holder door 105 of FIG. 2 in an open position relative to the sensor holder body 100. The sensor holder door 105 may include a door member 195, a distal door cap 200, a proximal door cap 205, and a compression spring 210. In the assembled state of the sensor holder door 105, the distal door cap 200 may be attached to the proximal door cap 205 via an opening 225 formed through the door member 195 such that the distal door cap 200 and the proximal door cap 205 are retained on distal and proximal surfaces, respectively, of the door member 195. The distal door cap 200 and the proximal door cap 205 may be slidably co-rotatable to a degree relative to door member 195. As described in further detail below, rotation of the distal door cap 200 via the proximal door cap 205 may transition the sensor holder door 105 between locked and unlocked states relative to the sensor holder body 100. The compression spring 210 may be attached to the distal door cap 200 and oriented such that the spring 210 is compressed between the distal door cap 200 and the sensor 90 (when installed) when the sensor holder door 105 is closed. The resultant force exerted by the spring 210 upon the sensor 90 ensures that gas tight seals are formed between the inlet and outlet ports 140, 150 of the sensor holder body 100 and corresponding inlet and outlet ports 455, 460 (FIG. 12B) of the sensor 90. In certain embodiments, each of the sensor holder door components may be fabricated from a suitable thermoplastic material (e.g., ABS plastic) using, for example, injection molding.

FIGS. 5A and 5B are proximal and distal perspective views, respectively, of the door member 195 of FIG. 4. The door member 195 may have a generally annular geometry and include an integral hinge 215 for pivotally attaching the door member 195 to the proximal end of the sensor holder body 100. The hinge 215 may extend from an outer perimeter of the door member 195 and include integral hinge pins 220. Each hinge pin 220 may be configured for engagement by a corresponding hinge barrel 190 of the flange 180 such that the door member 195 is pivotally moveable between open and closed positions relative to the sensor holder body 100 when the sensor holder door 105 is in an unlocked state. An inner perimeter of the door member 195 may define an opening 225 through which the distal and proximal door caps 200, 205 are joined. As shown in FIG. 5A, a proximal surface of the door member 195 may include a recessed seat portion 230 adjacent the opening 225. As shown in FIG. 5B, the distal surface of the door member 195 may similarly include a recessed seat portion 235 adjacent the opening 225. Each recessed seat portion 230, 235 generally functions to provide a circular “track” for receiving a corresponding portion of the proximal and distal door caps 205, 200, respectively, in order to slidably guide their rotation relative to the door member 195. As further shown in FIG. 5B, the distal surface of the door member 195 may include detent members 240, 245 formed by an outer perimeter of the recessed seat portion 235 on a half of the door member 195 generally opposite that of the hinge 215. The detent members 240, 245 may be configured for engaging corresponding detent notches 265, 270 (FIG. 6A) of the distal door cap 200 to limit the angle by which the distal door cap 200 and proximal door cap 205 may be co-rotated relative to the door member 195.

FIGS. 6A and 6B are distal perspective and side views, respectively, of the distal door cap 200 of FIG. 4. The distal door cap 200 includes a generally cylindrical collar 250 and disc-shaped base 255 attached to a proximal end of the collar 250. The base 255 may include a rim portion 260 extending beyond the outer perimeter of the collar 250 and define detent notches 265, 270. The base 255 may further include pins 271 oppositely positioned on and extending from the proximal surface of the base 255 to enable attachment of the caps 200, 205 via the opening 225. In the assembled state of the sensor holder door 105, the proximal surface of the rim portion 260 is received onto the recessed seat portion 235 of the door member 195 such that the detent notches 265, 270 are disposed between the detent members 240, 245 on the half of the door member 195 generally opposite that of the hinge 215. In this way, rotational travel of the distal door cap 200 relative to the door member 195 is limited in one direction by engagement of the detent member 240 by the detent notch 265. Rotation in an opposite direction is limited in the opposite direction by the engagement of detent member 245 by the detent notch 270. The collar 250 may include a lock tab 275 radially extending from its distal sidewall and generally aligned between the detent notches 265, 270. In the assembled state of the sensor holder door 105, rotation of the distal door cap 200 such the lock tab 275 is aligned with the first slot portion 192 of the lock tab slot 191 permits the sensor holder door 105 to be open and closed relative to the sensor holder body 100. When the sensor holder door 105 is closed, rotation of the distal door cap 200 such that the lock tab 275 is moved into and out of the second slot portion 193 of the lock tab slot 191 effects locking and unlocking, respectively, of the sensor holder door 105.

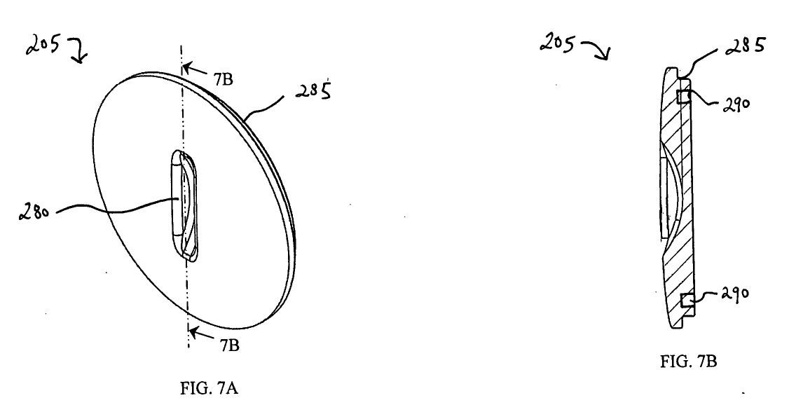

FIGS. 7A and 7B are a proximal perspective view and a cross-sectional side view taken along line 7B-7B, respectively, of the proximal door cap 205 of FIG. 4. As shown FIG. 7A, the proximal door cap 205 is generally disc-shaped and may include a drive socket 280 centrally positioned on its proximal surface that is shaped to receive a turning implement (e.g., a screwdriver, coin, etc.). As best shown in FIG. 7B, the distal surface of the proximal door cap 205 may include a recessed rim portion 285 and define pin sockets 290 oppositely positioned within an inner diameter of the recessed rim portion 285. In the assembled state of the sensor holder door 105, the proximal door cap 205 is positioned on the proximal surface of the door member 195 such that the rim portion 285 is rotationally seated against the recessed seat portion 230. Each pin 271 of the distal door cap 200 may be received into a corresponding pin socket 290 of the proximal door cap 205 such that the door caps 200, 205 are retained on the distal and proximal surfaces, respectively, of the door member 195.

Again referring to FIG. 2 in which the sensor holder door 105 is shown in the assembled state, it will thus be appreciated that the sensor holder door 105 may be transitioned between open and closed positions relative to the sensor holder body 100 by manually pivoting the sensor holder door 105 about its hinge 115. It will further be appreciated that the sensor holder door 105 may be locked and unlocked when in the closed position by selectively rotating the proximal door cap 205 via the drive slot 280 using a turning implement. For example, with reference to FIG. 4, the shape of the lock tab slot 191 may be such that rotation of the proximal door cap 205 in a clockwise direction subsequent to closing the sensor holder door 105 transitions the door 105 to the locked state.

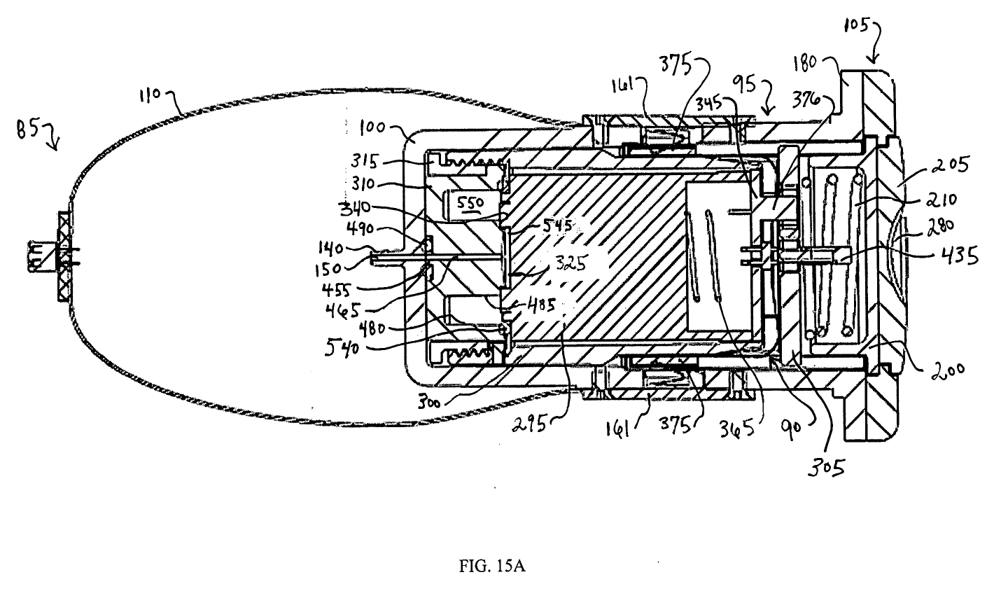

FIG. 8 is an exploded view of the sensor 90 of FIG. 2 from its distal end. The sensor 90 may include a sensor cell 295, a sensor sleeve 300, a proximal sensor cap 305, a distal sensor cap 310, and a distal sensor cap retainer 315. In the assembled state of the sensor 90 (FIG. 14), the sensor cell 295 may be recessably seated within a receptacle 405 of the sensor sleeve 300 and engaged on its distal face by the distal sensor cap 310. The distal sensor cap 310 is removably seated within the distal mouth of the receptacle 405 and forms a distal end of the sensor 90. The distal sensor cap 310 may interface the inlet and outlet ports 140, 145 of the sensor holder base 130 when the sensor 90 is contained within the sensor holder receptacle 135 and may be configured to communicate gas samples to and from the sensor cell 295. As described in further detail below, features of the distal sensor cap 310 are such that minimal dead space is introduced between the distal sensor cap 310 and the sensor cell 295. The distal sensor cap retainer 315 may be configured for progressive engagement by the distal end of the sensor sleeve 300 such that the distal sensor cap 310 is caused to press against the distal surface of the sensor cell 295 with a suitable force. The proximal sensor cap 305 may attach to the proximal end of the sensor sleeve 300 and includes features for properly orienting the sensor cell 295 within the sensor sleeve 300 and for aiding user insertion and removal of the sensor 90 to and from the receptacle 135 of the sensor holder 95. In certain embodiments, components of the sensor 90 including, for example, the sensor sleeve 300, the proximal and distal sensor caps 305, 310 and the distal sensor cap retainer 315, may be fabricated from a suitable thermoplastic material (e.g., ABS plastic) using, for example, injection molding.

FIGS. 9A and 9B are distal and proximal views, respectively, of the sensor cell 295 of FIG. 8. The sensor cell 295 may be, for example, a galvanic fuel cell and include features similar to those described above in connection with FIG. 1 (e.g., a cathode, anode, electrolyte solution, and a sensing membrane) for generating ionic current indicative of sensed oxygen content. The sensor cell 295 may include a cylindrically-shaped housing 320 having an opening 325 formed on its distal surface 330 through which gas samples may be received and exhausted via the distal sensor cap 310. The distal surface 330 may include an outer rim portion 335 and an inner rim portion 340 elevated relative to the outer rim portion 335 and disposed about the perimeter of the opening 325. In the assembled state of the sensor 90 and as described in further detail below, the outer and inner rim portions 335, 340 of the sensor cell 295 may engage a lip 451 and a gas distribution nozzle 440, respectively, of the distal sensor cap 310.

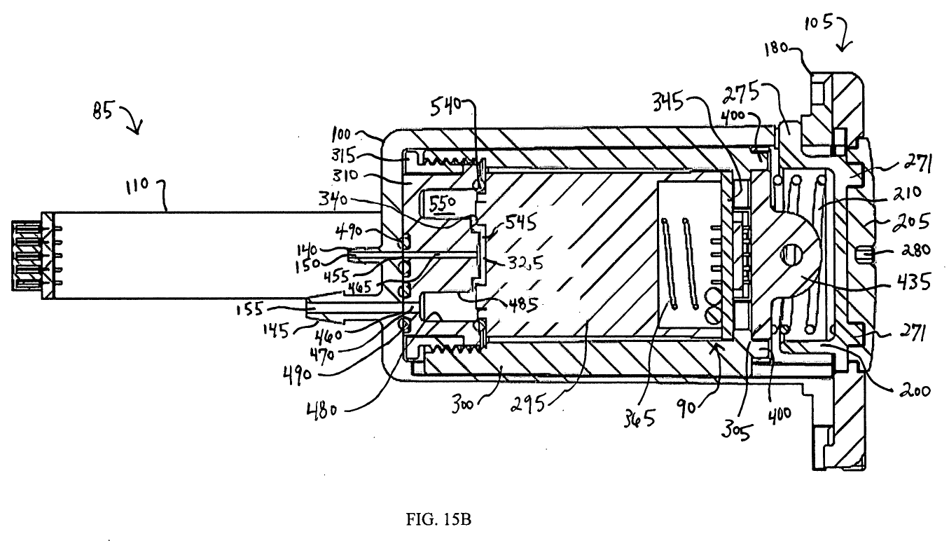

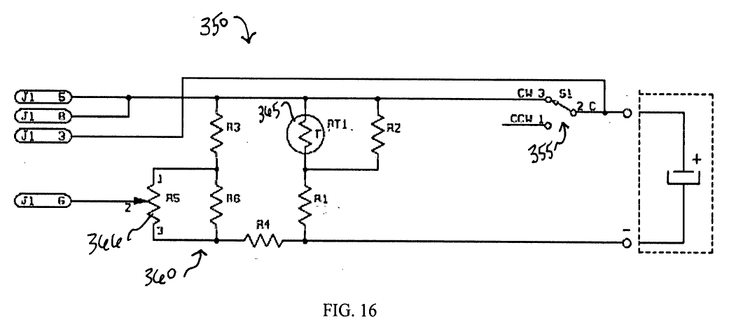

As shown in FIG. 9B, the sensor cell 295 may further include a PCB 345 mounted on its proximal end and in electrical communication with a cathode and an anode (not shown) of the sensor cell 295. In certain embodiments, the PCB 345 may include signal conditioning circuitry for suitably processing ionic current generated by the sensor cell 295. FIG. 16 is a schematic diagram of a circuit 350 according to one such embodiment. The circuit 350 may include a switch 355 for optionally directing the ionic current through a resistor network 360 in order to generate a voltage output signal proportional to the ionic current, and thus, the sensed oxygen content. As shown, the resistor network 360 may include a thermistor element 365 for altering the resistance of the network 360 based on a sensed temperature of the sensor cell 295. In certain embodiments, for example, the thermistor element 365 may be structured to distally extend from the PCB 345 into the sensor cell 295 to ensure that the internal temperature of the sensor cell 295 is accurately sensed (FIGS. 15A and 15B). It will be appreciated that error in the voltage output signal of the resistor network 360 arising due to temperature fluctuations within the sensor cell 295 may be compensated by the thermistor 365 to an extent. As an alternative to generating a temperature-compensated voltage output signal, the circuit 350 may be configured to directly output the ionic current signal by suitably manipulating the switch 355. The resistor network 360 may also include a variable resistor 366 for adjusting and/or calibrating the output signal of the circuit 350 as necessary.

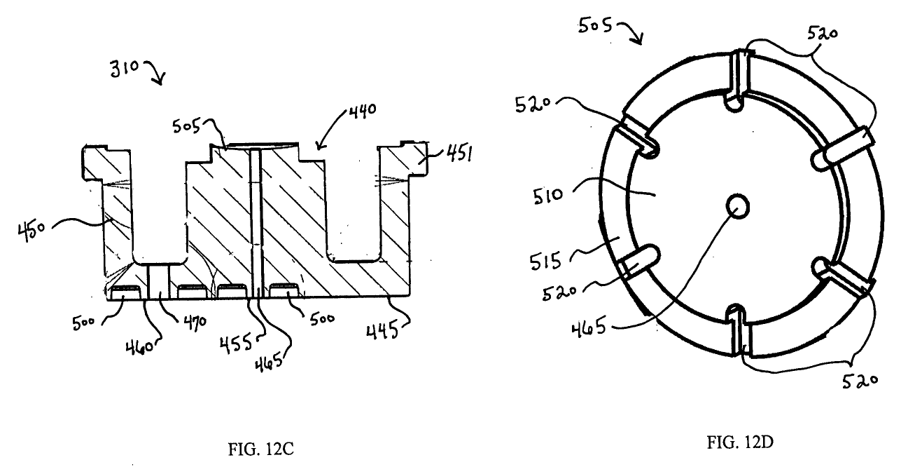

The PCB 345 may further include a multi-conductor sensor cable 370 connected to the circuit 350 for communicating signals output by the circuit 350 to the sensor holder cable 110. The sensor cable 370 may include, for example, a male pin header (not shown) electrically coupled to the sensor cable's 370 midsection and configured to engage a corresponding female pin header (not shown) mounted on the PCB 345 and coupled to the circuit 350. The conductors at each end of the sensor cable 370 may terminate on a corresponding electrical wipe of a modular contact 375. Each modular contact 375 may be mounted on an exterior sidewall 380 (FIG. 10A) of the sensor sleeve 300 such that when the sensor 90 is contained within the receptacle 135 of the sensor holder 195, each electrical wipe of the modular contact 375 is aligned with and contacts a corresponding electrical wipe of a corresponding modular contact 161 of the sensor holder cable 110. To ensure correct rotational alignment of the PCB 345 relative to the sensor sleeve 300 (e.g., rotational alignment such that the modular contacts 375 may be mounted on the sensor sleeve 300 without unduly twisting or straining the sensor cable 370), the PCB 345 may include an alignment post 376 configured for receipt through a corresponding alignment aperture 430 (FIGS. 11A and 11B) of the proximal sensor cap 305.

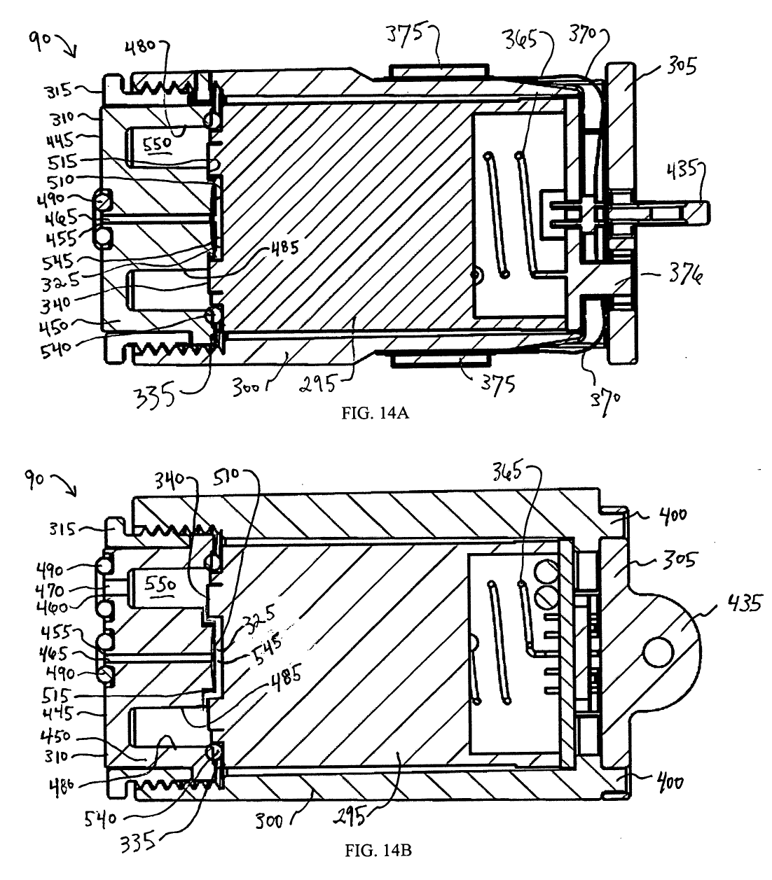

FIGS. 10A and 10B are a proximal perspective view and cross-sectional side view taken along line 10B-10B, respectively, of the sensor sleeve 300 of FIG. 8. The sensor sleeve 300 may include a generally cylindrical sidewall 380 having an interior surface 385 and an exterior surface 390. The sensor sleeve 300 may further include a split rim portion 395 integrally formed on the proximal end of the sidewall 380 and extending inwardly therefrom. A proximal surface of the rim portion 395 may include pins 400 formed thereon for attachment of the proximal sensor cap 305 to the sensor sleeve 300, as further described below. The interior sensor sleeve surface 385 and the rim portion 395 together define a receptacle 405 into which the sensor cell 295 may be recessably seated from the distal end of the sensor sleeve 300 such that a distal surface of the rim portion 395 engages and retains an opposing proximal surface of the sensor cell 295. With reference to FIG. 8, a portion of the interior sensor sleeve surface 385 adjacent the distal end of the receptacle 405 may include threads 410 for removably engaging oppositely gendered threads 530 (FIG. 13) of the distal sensor cap retainer 315.

Referring again to FIGS. 10A and 10B, the sensor sleeve 300 also may include generally planar mounting surfaces 415 formed on opposing sides of the exterior sidewall surface 390 to which corresponding modular contact 375 of the sensor cable 370 attach. The exterior sidewall surface 390 may additionally include an alignment key 420 in the form of a raised lip extending longitudinally over the length of the sensor sleeve 300. As discussed above in connection with FIGS. 3A, 3C and 3D, the alignment key 420, in combination with the key slot 175 of the sensor holder 95, mechanically polarizes the sensor 90 with respect to the sensor holder 95 such the sensor 90 may only be received into the receptacle 135 when in the correct rotational orientation.

FIGS. 11A and 11B are proximal and distal perspective views, respectively, of the proximal sensor cap 305 of FIG. 8. The proximal sensor cap 305 may be generally disc-shaped and define pin holes 425 adjacent its outer perimeter. The proximal sensor cap 305 may also define an alignment aperture 430. In the assembled state of the sensor 90, each pin hole 425 may receive a corresponding pin 400 of the sensor sleeve 300 such that the proximal sensor cap 305 is retained on the proximal end of the sensor sleeve 300. Additionally, the alignment aperture 430 may receive the alignment post 376 of the PCB 345 to ensure correct rotational alignment of the PCB 345 relative to the sensor sleeve 300. As shown in FIG. 11A, the proximal sensor cap 305 may include an extraction tab 435 extending from its proximal surface. The extraction tab 435 may be generally D-shaped and enable a user to grasp the proximal end of the sensor 90 so that it may be inserted into or removed from the receptacle 135 of the sensor holder 95 as necessary.

FIGS. 12A and 12B are proximal and distal perspective views, respectively, of the distal sensor cap 310 of FIG. 8, and FIG. 12C is a cross-sectional view of the embodiment of the distal sensor cap 310 shown in FIG. 12A taken along line 12C-12C. As shown in FIG. 12A, the distal sensor cap 310 may include a generally cylindrical gas distribution nozzle 440 integrally formed on a circular base 445 and extending in a normal direction therefrom. The distal sensor cap 310 may further include a cylindrically shaped sidewall 450 extending in a proximal direction from a perimeter of the base 445 such that the gas distribution nozzle 440 is coaxially oriented relative to the sidewall 450 and generally co-extensive therewith. A lip 451 may be disposed on the proximal end of the sidewall 450 and may include a distal surface for engaging an opposing surface of the distal sensor cap retainer 315. The lip 451 may further include a notch 452 configured to receive a pin 453 (FIG. 8) that extends through the interior sensor sleeve sidewall 385 via a pin aperture 454 to ensure correct rotational alignment of distal sensor cap 310 relative to the sensor sleeve 300.

As best shown in FIGS. 12B and 12C, the base 445 of the distal sensor cap 310 may include an inlet port 455 centrally positioned on its distal surface, and an outlet port 460 positioned on the distal base surface between the inlet port 455 and the sidewall 450. The inlet port 455 and the gas distribution nozzle 440 may collectively define coaxial bore 465 having a first end that opens from a distal end of the inlet port 445 and a proximal end that opens from a proximal surface 505 (FIG. 12A) of the gas distribution nozzle 440. The outlet port 460 may define a coaxial bore 470 having a first end that opens from a distal end of the outlet port 460 and a second end that opens from a proximal surface of the base 445. The positions of the inlet and outlet ports 455, 460 on the base 445 are such that, when the sensor 90 is contained within the receptacle 135 of the sensor holder 95, the inlet and outlet ports 455, 460 are respectively aligned and sealably interfaced with the inlet and outlet ports 140, 145 of the sensor holder 95. To establish sealed communication between the aligned inlet and outlet ports, the inlet and outlet ports 455, 460 each may include a seal member 490 (FIG. 8), such as an O-ring gasket, seated in a recess 500 formed therearound. When seated in the recesses 500, a portion of each seal member 490 may protrude beyond the distal surface of the base 445 such that the seal members 490 are compressed (e.g., by the force exerted on the sensor 90 by the compression spring 210 of the sensor holder door 105) to form gas tight seals between the inlet ports 140, 455 and outlet ports 460, 145, respectively.

FIG. 12D is a detailed view of the proximal surface 505 of the gas distribution nozzle 440. The surface 505 may include a generally circular center portion 510 elevated above an adjacent rim portion 515 and containing the second end of the bore 465. The surface 505 may define a plurality of exhaust vents 520 symmetrically distributed about its periphery. Each of the exhaust vents 520 may be in the form of a slot beginning on a periphery of the center portion 510 and extending radially outward through the rim portion 515 to open through an exterior sidewall 485 of the gas distribution nozzle 440. Although six exhaust vents 520 are depicted in FIG. 12D, it will be appreciated this number may be increased or decreased depending on particular requirements of the system such as, for example, the size of each exhaust vent 520 and the volume of gas samples introduced from the outlet port 465 to the sensor cell 295.

FIG. 13 is a distal perspective view of the distal sensor cap retainer 315. The distal sensor cap retainer 315 may include a collar 525 configured to be slidably received over the distal end of the distal sensor cap 310. The collar 525 further include threads 530 formed an exterior surface thereof to engage oppositely gendered threads 410 of the interior sensor sleeve surface 385. The distal sensor cap retainer 315 may further include a rim 535 integrally formed on the distal end of the collar 525 and outwardly extending beyond the perimeter of the collar 525. Engagement of the threads 410, 520 causes the collar 525 to threadably advance into the receptacle 405 of the sensor sleeve 300 such that the proximal end of the collar 525 is caused to engage the distal surface of the lip 451 of the distal sensor cap 310, which in turn causes the distal sensor cap 310 to be forcibly pressed against the distal surface of the sensor 90.

In the assembled state of the sensor 90 and with reference to FIGS. 14A and 14B, the distal face of the sensor cell 295 may be engaged by distal sensor cap 310 by virtue of the advancement of the distal sensor cap retainer 315 into the sensor sleeve 300, as described above. The center portion 510 of the proximal nozzle surface 505 may be received into the opening 325 of the sensor cell 295, while a part of the rim portion 515 of the proximal nozzle surface 505 may be seated against a part of the inner rim portion 340 of the sensor cell 295 adjacent the opening 325. The proximal surface of the sidewall 450 of the distal sensor cap 310 may form a gas tight seal against the outer rim portion 335 of the sensor cell 295 via a seal member 540 (e.g., an O-ring gasket) disposed therebetween. Accordingly, engagement of the distal face of the sensor cell 295 by the distal sensor cap 310 defines first volume 545 and a second volume 550. The first volume 545 is generally bounded by the center portion 510 of the proximal nozzle surface 505 and the opening 325 of the sensor cell 295, while the second volume 550 generally bounded by an interior surface 480 of the sidewall 450, the sidewall 485 of the gas distribution nozzle 440, the proximal surface of the base 445, and a part of the inner rim portion 340 of the sensor cell 295. Because the exhaust vents 520 open on the center portion 510 of the proximal nozzle surface 505 and on the sidewall 485 of the gas distribution nozzle 440, the first and second volumes 545, 550 are interconnected by passageways defined by the exhaust vents 520 and the inner rim portion 340 of the sensor cell 295.

With reference to FIGS. 15A and 15B, gas samples received into the inlet port 140 of the sensor holder 95 may be communicated directly to the first volume 545 (and thus the opening 325 of the sensor cell 295) via a common inlet port bore defined by the bores 150, 465. The gas sample may subsequently be exhausted from the sensor cell 295 into the second volume 550 via the passageways defined by the exhaust vents 520 and the inner rim portion 340 of the sensor cell 295. From the second volume 550, the exhausted gas sample may be directed to the outlet port 145 of the sensor holder 95 via a common outlet bore defined by bores 470, 155. Gas samples may continually flow to and from the sensor 90 by maintaining the pressure at the inlet port 140 higher relative to that of the outlet port 145. The differential pressure across the sensor 90 may be selected such that a suitable sample flow rate is provided, while at the same time preventing undue compression of the gas samples (thus affecting oxygen concentration) and damage to components of the sensor cell 295.

It will be appreciated that the system 85 may significantly improve the ability to accurately measure oxygen content in many applications utilizing galvanic-type oxygen sensors. For example, in contrast to conventional sensor holder arrangements in which the introduction and exhaust of gas samples to and from a sensor may require circulation of gas samples throughout a substantial internal volume of the sensor holder, the sensor 90 and the sensor holder 95 significantly lessen the volume needed to perform these steps by interfacing the inlet port 140 of the sensor holder 95 directly to the sensor cell opening 325 via the distal sensor cap 310. Additionally, in order to prevent a buildup of excessive pressure within the first volume 545, the size and number of exhaust vents 520 may be selected such that the total cross-sectional area of the exhaust vents 520 exceeds the cross-sectional area of the bore 465 from which gas samples are received.

It will further be appreciated that the system 85 is particularly amenable to fast oxygen sensing applications which heretofore have been generally viewed as incompatible with sensor holder arrangements. In addition to reducing dead space to a level commensurate with that of conventional fast oxygen sensors, the system 85 allows the sensor 90 to be quickly and efficiently replaced from the exterior of its host equipment simply by unlocking the sensor holder door 105, pulling the expired sensor from the receptacle 135, and inserting a new sensor therein. As noted above, this feature may be particularly attractive in certain oxygen monitoring applications in which significant interruptions in gas sampling may be unacceptable.

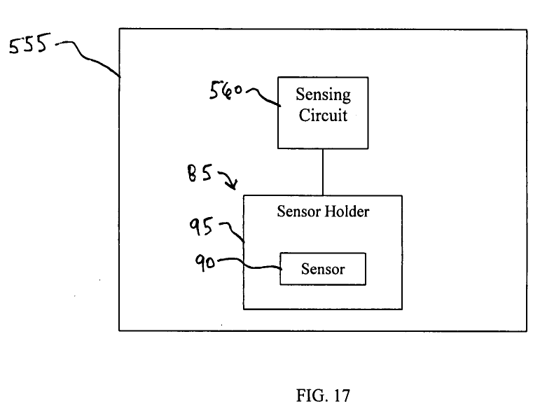

FIG. 17 illustrates a schematic diagram of a host 555 in which the system 85 has been integrated. As noted above, the host 555 may generally be any type of equipment that requires or otherwise benefits from the use of a galvanic-type oxygen sensor to determine the oxygen content of gas samples. In certain embodiments, for example, the host 555 may be an oxygen analyzer for use in an industrial environment or other setting. In other embodiments, the host 555 may be an item of respiratory equipment (e.g., ventilator, pulmonary diagnostic device, etc.). In addition to the system 85, the host 555 may comprise a sensing circuit 560 for receiving output signals from the system 85 via a suitable electrical connector 111 (FIG. 2) of the sensor holder cable 110, and an enclosure 565 housing the system 85 and the external sensing circuit 560. As shown in FIG. 17, the system 85 may be mechanically attached to a flat exterior surface of the enclosure 565 via the mounting flange 180 of the sensor holder body 100.

The sensing circuit 560 may be any known sensing circuit for converting output signals received from the system 85 into an oxygen concentration reading. According to various embodiments, the sensing circuit 560 may include one or more microprocessors, signal processors, power supplies, data input devices, and display devices for implementing the conversion and for outputting and/or utilizing the corresponding result.

The enclosure 565 may be any type of known enclosure suitable for housing the system 85 and the sensing circuit 560 and for accommodating process lines and other components necessary for the delivery and exhaust of the gas samples to and from the system 85.

It is to be understood that the figures and descriptions of the present application have been simplified to illustrate elements that are relevant for a clear understanding of the disclosed subject matter. Those of ordinary skill in the art will recognize that these and other elements may be desirable. However, because such elements are well known in the art and because they do not facilitate a better understanding of the present application, a discussion of such elements is not provided herein.

While several embodiments have been described, it should be apparent that various modifications, alterations and adaptations to those embodiments may occur to persons skilled in the art with the attainment of some or all of the advantages disclosed in the present application. For example, while certain components of the system 85 are described above as being integral with other elements (e.g., hinge barrels 190 may be integral with flange 180), it will be appreciated that the elements may instead be formed separately and joined thereafter. It is therefore intended to cover all such modifications, alterations and adaptations without departing from the scope and spirit of the present application as defined by the appended claims.

Any patent, publication, or other disclosure material, in whole or in part, that is said to be incorporated by reference herein is incorporated herein only to the extent that the incorporated materials do not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A system comprising:
a sensor comprising an inlet port for receiving a gas sample and an outlet port for exhausting a portion of the gas sample, the sensor to generate an output signal indicative of an oxygen concentration of the gas sample;
a sensor holder to removably receive and contain the sensor, the sensor holder comprising an inlet port for communicating the gas sample to the sensor and an outlet port for receiving the exhausted portion of the gas sample from the sensor;
wherein the inlet port of the sensor holder is aligned and sealably interfaced with the inlet port of the sensor, the inlet ports defining a common inlet bore; and
wherein the outlet port of the sensor holder is aligned and sealably interfaced with the outlet port of the sensor, the outlet ports defining a common outlet bore.

2. The system of claim 1, wherein sensor is removably received and contained in a receptacle defined by the sensor holder.

3. The system of claim 2, wherein the sensor is polarized with respect to the sensor holder such that the sensor is insertable into the receptacle only when the sensor is in a predetermined rotational orientation with respect to the sensor holder.

4. The system of claim 2, wherein the sensor holder comprises a door to access the receptacle, the door attached to the sensor holder and moveable between an open position and a closed position with respect to a body of the sensor holder.

5. The system of claim 4, wherein the door is selectively lockable in the closed position.

6. The system of claim 1, wherein the sensor comprises a printed circuit board (PCB).

7. The system of claim 6, wherein the PCB includes a circuit for compensating temperature-induced error of the output signal.

8. The system of claim 6, wherein the PCB comprises an electrical contact for communicating the output signal from the sensor to a corresponding electrical contact of the sensor holder.

9. The system of claim 1, wherein the sensor comprises:
a sensor cell comprising a surface forming an opening to receive the gas sample; and
a gas sensor cap comprising the inlet and outlet ports of the sensor;
wherein the gas sensor cap engages the surface of the sensor cell to define a first volume and a second volume, the first volume to receive the gas sample from the inlet port of the sensor and communicate the gas sample to the opening of the sensor cell, and the second volume to receive the exhausted portion of the gas sample from the first volume and communicate the exhausted portion of the gas sample to the outlet port of the sensor.

10. The system of claim 9, wherein engagement of the sensor cell surface by the gas sensor cap defines at least one passageway connecting the first volume to the second volume.

11. The system of claim 9, wherein the second volume is greater than the first volume.

12. The system of claim 4, comprising a host to receive the output signal from the sensor, wherein the sensor holder is attached to the host such that the door of the sensor holder is accessible from an exterior surface of the host.

13. An apparatus comprising:
a sensor cell comprising a surface forming an opening to receive a gas sample, the sensor to generate an output signal indicative of an oxygen concentration of the gas sample;
a gas sensor cap comprising an inlet port and outlet port, the sensor cap to engage the surface of the sensor cell to define a first volume and a second volume, the first volume to receive the gas sample from the inlet port and communicate the gas sample to the opening of the sensor cell, and the second volume to receive an exhausted portion of the gas sample from the first volume and communicate the exhausted portion of the gas sample to the outlet port; and
a sleeve to contain the sensor cell and the gas sensor cap;
wherein the apparatus is configured to be removably received and contained in a sensor holder such that inlet and outlet ports of the gas sensor cap are respectively aligned and sealably interfaced with the inlet and outlet ports of the sensor holder to define a common inlet bore and a common outlet bore.

14. The apparatus of claim 13, wherein engagement of the sensor cell surface by the gas sensor cap defines at least one passageway connecting the first volume to the second volume.

15. The apparatus of claim 13, wherein the second volume is greater than the first volume.

16. The apparatus of claim 13, wherein the sleeve comprises an alignment key to engage a key slot of the sensor holder such that the apparatus is insertable into a receptacle defined by the sensor holder only when the apparatus is in a predetermined rotational orientation with respect to the sensor holder.

17. The apparatus of claim 13, comprising a printed circuit board (PCB) in electrical communication with the sensor cell.

18. The apparatus of claim 17, wherein the PCB includes a circuit for compensating temperature-induced error of the output signal.

19. The apparatus of claim 17, wherein the PCB comprises an electrical contact to communicate the output signal to a corresponding electrical contact of the sensor holder.
